(19) United States
(12) Patent Application Publication
(10) Pub. No.: US 2005/0262709 A1
(43) Pub. Date: Dec. 1, 2005

(54) Candle grooming tool

(76) Inventor: Bernard Polk SR., Charlotte, NC (US)

Correspondence Address: DOUGHERTY, CLEMENTS, HOFER, BERNARD & WALKER, 1901 ROXBOROUGH ROAD, SUITE 300, CHARLOTTE, NC, 28211, US

(21) Appl. No.: 11/195,019

(22) Filed: Aug. 2, 2005

Related U.S. Application Data
(63) Continuation-in-part of application No. 29/199,299, filed on Feb. 13, 2004, now Pat. No. D508389.

(51) Int. Cl. B26B 7/00; B27B 3/12

(52) U.S. Cl. 30/392

(57) ABSTRACT

A heated sculpting tool for the sculpting and grooming of candles, foam materials, and the like. The sculpting tool has a handle that contains a power source and a heating element. A serrated blade having a chiseled tip extends outwardly from the handle. Heat is passed from the heating element to the blade. A temperature regulator is provided to maintain blade temperature in the optimal functioning range.

### CROSS REFERENCE TO RELATED APPLICATION

This Continuation-in-Part application claims the benefit of the Design patent application Ser. No. 29/199,299 filed on Feb. 13, 2004.

### FIELD OF THE INVENTION

This invention relates generally to equipment used in the carving and artistic shaping of wax candles and sculptures and, more specifically, to heated knives and saws used in the carving and artistic shaping of wax candles and sculptures.

### BACKGROUND OF THE INVENTION

In recent years, candles have seen a resurgence in popularity. While once used for lighting purposes, candles now provide decoration and pleasing aromas to a person's home, office or other area. The use of candles as decoration has led to a demand for more artistic and aesthetically sculpted candles. Indeed, many candles will be utilized solely as decoration, never to be lit.

The need for equipment to make these artistic candles has grown with the demand for the candles themselves. However, current candle carving and sculpting tools often do not provide an easy way to aesthetically cut the waxy candle material without marring the surface of the candle itself Hot cutting tools of the prior art often consist of closed loops, which make the carving of details within the candle nearly impossible.

Thus, there remains a need in the art for a candle sculpting tool that can easily and aesthetically slice through waxy candle material, and still be able to carve intricate details as well.

### DESCRIPTION OF THE PRIOR ART

U.S. Pat. No. 6,434,836, issued to Olivares, discloses an electric knife that runs on a battery or by use of a corded power converter. The handle housing has an electric reciprocating motor activated by a power button located on the handle of the knife. Different sizes and shapes of knife blades, dependent on the task, can be inserted into a locking slot in the front of the motorized head, and only released by a heavy-duty lock knife release button. The motorized head is powered directly by an electric motor located directly behind it in the handle.

U.S. Pat. No. 6,754,967, issued to Lovell et al., discloses a saw blade that is connected to a hand held driver for reciprocating the saw blade to perform a cut. A bit holder and a blade holder is used to provide connection between the saw blade and the handle of the hand held driver. The bit holder includes a connecting mechanism for connecting the bit holder to the hand held driver. The blade holder provides a connection between the saw blade and the bit holder. The blade holder includes a holder body and a hex-shaped shank extending rearwardly from the holder body. The shank further includes a first holding mechanism for coupling the holder to the bit holder at the rear end and a second holding mechanism for coupling the saw blade to the holder at the forward end.

U.S. Pat. No. 3,679,958, issued to Chambers, discloses a battery operated electric knife having an elongated housing defining the knife handle and enclosing an electric motor and batter unit. A pair of charging contacts are mounted entirely within the elongated housing with access openings thereto below the motor. A charging and storage stand are provided shaped to receive the knife handle in only one predetermined position, whereby said housing for the electric knife may be resiliently clamped in assembled relationship with the charging unit. An improved permanent magnet rotor is employed having an outer field member comprising a resilient cylindrical shell with a slit there.

### SUMMARY OF THE INVENTION

Briefly described, the present invention is a novel modeling tool for the cutting and sculpting of wax, plastic, foam, and the like. The tool has a handle with a heated blade attached thereto, the blade having a serrated edge. The tip of the heated blade is contoured like a chisel, to facilitate gouging and cutting within confined areas.

The candle sculpting tool generally consists of a hollow, insulated handle containing a heating element and a temperature regulator switch. The heating element is connected to a blade extending from one end of the handle. The heating element is typically a poor conductor, which will become hot upon current flowing through it. To prevent overheating of the heating element, there is a thermal switch that shuts off the current when the heating element gets to a pre-set temperature. A power supply is connected to the thermal switch, to provide power to the heating element. An on-off switch connects the power supply to the thermal switch.

A blade is connected to the heating element, such that heat is transferred to the blade as current is passed through the heating element. The blade is preferably serrated to facilitate ease of cutting through a variety of substrates. The tip of the blade can be beveled to form a chisel in order to ease cutting and trimming in confined spaces.

### OBJECTS OF THE INVENTION

It is one object of the current invention to provide an improved modeling tool for the cutting and sculpting of wax, plastic, foam, and the like.

It is another object of the current invention to provide an improved modeling tool for the cutting and sculpting of wax, plastic, foam, and the like, wherein the tool has a heated blade.

It is another object of the current invention to provide an improved modeling tool with a heated blade for the cutting and sculpting of wax, plastic, foam, and the like, wherein the blade has a chisel end to facilitate gouging and cutting within confined areas.

### BRIEF DESCRIPTION OF THE DRAWINGS

The above-mentioned and other features and objects of the invention will become more readily apparent and the invention itself will be better understood by reference to the following detailed description taken in conjunction with the accompanying drawings, wherein:

FIG. 1 is a perspective view of the sculpting tool.

FIG. 2 is a cross-sectional view of the handle of the sculpting tool of FIG. 1.

FIG. 3 is an enlargement of the serrated edge of the sculpting tool of FIG. 1.

### DETAILED DESCRIPTION

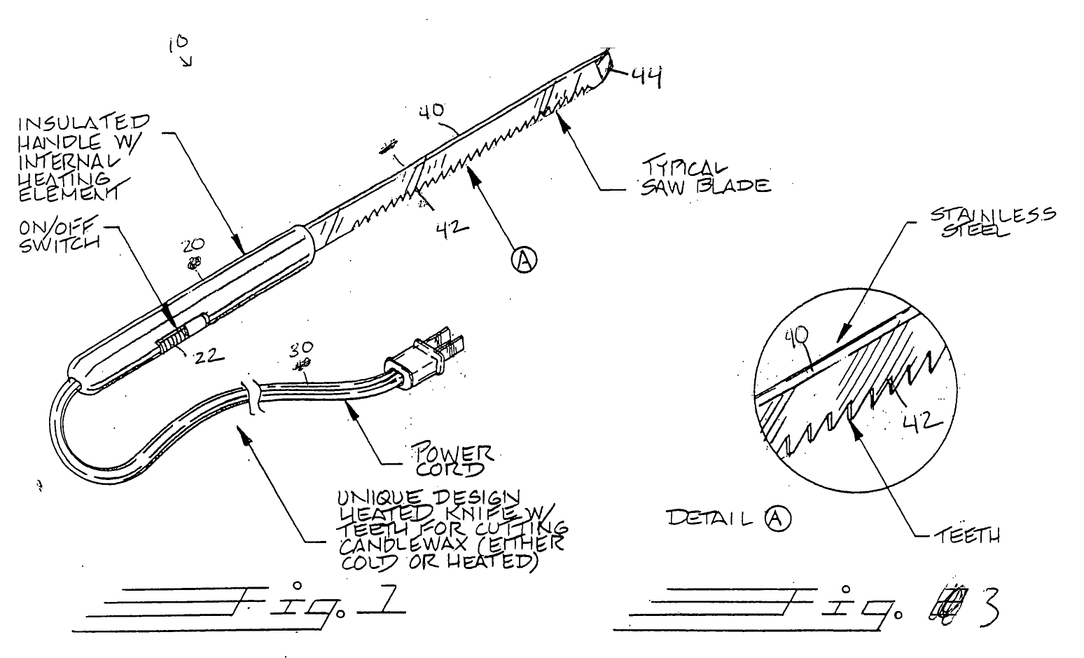

Referring to FIG. 1, the sculpting tool 10 consists broadly of a handle 20, a power supply 30, and a blade 40.

The handle 20 can be made from any material, or made into any shape known in the art. Attached externally to the handle is a power toggle switch 22. Switch 22 is preferably located in an ergonomically comfortable position on the handle, proximate to where a user's thumb would rest when grasping the handle. Switch 22 can be any type of switch known in the art, such as a rocker switch, a slider switch, a depressible button, or the like, and the selection of the switch type is not limiting of the invention. The switch is toggled between an “on” setting, and an “off” setting, in order to supply or interrupt the flow of current between the power supply 30 and the regulator switch 24.

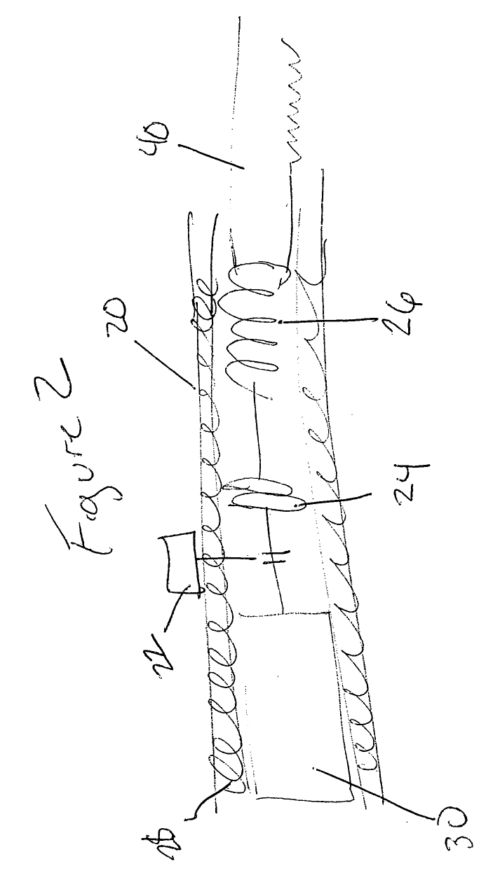

Referring now to FIG. 2, regulator switch 24 and heating element 26 are located within the handle 20. Regulator switch 24 is provided to control the temperature of the heating element. When the regulator switch 24 reaches a predetermined temperature, the switch disconnects, preventing further flow of current to the heating element. The type regulator switch used is non-limiting, and the invention encompasses all types of switches known in the art. Preferably, however, the switch is a bimetallic type switch.

Regulator switch 24 is coupled between a heating element 26, and a power source 30. The heating element is preferably a heating coil, and can made from any material known in the art. The heating element 26 is attached to the blade 40, either directly or indirectly, which extends from one end of the handle 20.

Insulation 28 may be provided within the handle to prevent destruction or marring of the handle itself.

Power source 30 can be either a direct current source, such as a battery, or an alternating current source, such as provided by an electrical plug. Further, the power source could be some combination of the above, such that the handle 20 has an internal rechargeable battery, and an external docking station (not shown) that would plug into an electrical socket.

Blade 40 is attached to the heating element 26, and extends outward from the handle 20. The blade can be made of any material known in the art capable of withstanding the elevated temperatures present when the blade is heated. Preferred materials include stainless steel, and chrome or nickel plated materials. The blade is normally between 6 to 7 inches in length, although this should not be seen as limiting. A longer or shorter blade could be used, depending on the specific application desired.

The blade 40 preferably has one serrated edge 42. Serrations are typically provided in a range of from about 16 to about 18 teeth per inch. It has been found that this range provides a smooth cut at a very fast pace, allowing the user to trim large amounts of material, or make small precise decorative cuts with the same instrument. While the blade is shown as having Japanese-type serrations, American-type serrations can also be used. That is, the serrations can be oriented so that the cut is performed on either the push or the pull of the sculpting tool.

The tip of the blade 40 is beveled to form a chisel tip 44. The chisel tip 44 facilitates plunge cuts into materials. Furthermore, it also allows the user to trim small amounts of material from confined spaces, allowing the user to create more intricate detail in the carved material

In use, the user turns the power toggle switch 22 to the “on” position. Current then flows from the power source 30, to the heating element 26. The resistance of the heating element 26 causes it to heat as current passes through it. When the heating element reaches a predetermined maximum temperature, the regulator switch 24 temporarily interrupts the current flow to the heating element, and allows it to cool. When the heating element reaches a predetermined minimum temperature, the regulator switch 24 reconnects the flow of current to the heating element 26, and the cycle repeats.

Heat is transferred from the heating element 26 to the blade 40. A user can then use the sculpting tool to easily sculpt and cut heat sensitive materials, such as candle wax, foam blocks and the like.

### SUMMARY OF THE ACHIEVEMENT OF THE OBJECTS OF THE INVENTION

From the foregoing, it is readily apparent that I have invented a novel modeling tool with a heated blade for the cutting and sculpting of wax, plastic, foam, and the like, wherein the blade has a chisel end to facilitate gouging and cutting within confined areas. It is further apparent that the invented sculpting tool can comprise a heating element within the handle, and that the handle is internally insulated to prevent transfer of heat to the surface of the handle where it could cause injury to the operator. Further, it is apparent that the heated blade of the invented sculpting tool is provided with serrations thereon to cleanly and quickly cut through a variety of heat sensitive materials.

It is to be understood that the foregoing description and specific embodiments are merely illustrative of the best mode of the invention and the principles thereof, and that various modifications and additions may be made to the apparatus by those skilled in the art, without departing from the spirit and scope of this invention. Accordingly, it is intended to embrace all such alternatives, modifications, and variations. The present embodiments are to be considered as illustrative and not restrictive, and the invention is not to be limited to the details given herein, but may be modified within the scope and equivalents of the appended claims.

1. A sculpting tool for the cutting and sculpting of wax, plastic, foam, and the like, comprising a heated blade having a first and second end, and an edge; said first end being integrally attached to a handle, and wherein said second end has a sharp beveled edge forming a chisel.

2. The sculpting tool of claim 1, wherein said handle further comprises a heating element therein capable of providing thermal energy to said blade.

3. The sculpting tool of claim 2, further comprising a switch for toggling power to said heating element.

4. The sculpting tool of claim 2, wherein said heating element is powered by an alternating current.

5. The sculpting tool of claim 2, wherein said heating element is powered by a voltaic cell, a storage cell, or a battery.

6. The sculpting tool of claim 1, wherein said handle further comprises an insulating material.

7. The sculpting tool of claim 6, wherein said insulating material is disposed within said handle.

8. The sculpting tool of claim 1, wherein said edge is serrated.

9. The sculpting tool of claim 8, wherein said edge contains between about 16 and about 18 serrations per inch.

10. The sculpting tool of claim 1, wherein said heated blade is at least 5 inches in length.

11. The sculpting tool of claim 1, wherein the composition of said heated blade is selected from the group consisting of stainless steel, nickel plated alloys, chrome plated alloys, or combinations thereof.

12. The sculpting tool of claim 1, further comprising a temperature regulator switch wherein said temperature regulator switch is capable of interrupting current flow to the heating element when said heating element reaches a predetermined temperature.

13. The sculpting tool of claim 12, wherein said temperature regulator switch is a bimetallic type regulator switch.
